(19) United States
(12) Patent Application Publication
(10) Pub. No.: US 2005/0120057 A1
(43) Pub. Date: Jun. 2, 2005

(54) Information processing device for managing data storage and method of data management

(76) Inventors: Hirobumi Hashimoto, Tokyo (JP); Koichi Ishii, Tokyo (JP); Tetsuji Ohno, Yokohama (JP); Tatsuya Saito, Tokyo (JP); Masahiro Nagakura, Yamato (JP); Katsuya Yokomura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/984,987

(22) Filed: Nov. 10, 2004

(30) Foreign Application Priority Data
Nov. 10, 2003 (JP) 2003-379857

(51) Int. Cl. G06F 12/00

(52) U.S. Cl. 707/200

(57) ABSTRACT

The cost of service provision for data storage is minimized, particularly for temporary storage of data. An information processing device includes: a storage case searching unit that accepts a data storage request from an input interface and searches cases in which data can be stored in a data center having a free capacity of at least the size of the storage data, as indicated in the data storage request and a data center table; a storage cost calculation unit that calculates the storage cost required for each case; a default cost calculation unit that calculates the default cost required for each case; and a case selection unit that calculates the total cost for each case and selects whether the data is stored in the data center or whether a data storage request is made to the data center, according to the case for which the total cost is a minimum.

This application relates to and claims priority from Japanese Patent Application No. 2003-379857, filed on Nov. 10, 2003, the entire disclosure of which is incorporated herein by reference.

### BACKGROUND

The present invention relates in general to an information-processing device and to a method for managing data in response to client requests; and more particularly, the invention relates to a program-recording medium and to a technique for automatically selecting a data storage destination in accordance with the cost of the service provision in the case of data storage.

With the spread of large-capacity networks, the occasions on which an enterprise or individual (hereinbelow called a “user”) uses the service provided by a service provider or a data center via a network have increased. Recently, also, the many service providers and databases that have been established are being mutually linked to supplement services and to improve the efficiency of their operation.

For example, it has been made possible for a service provider that provides a service to a user to easily respond to changes of data capacity by utilizing a data center for purposes of data storage.

As a example of such a technique, there is a data management system (see Laid-open Japanese Patent Application Number 2002-32333) comprising a first network, a group of service providers connected with this first network, a data center for holding the service content connected with said first network, a second network, and a user terminal connected with one of said service providers through this second network, wherein the service content held in said data center is downloaded to said user terminal through said first and second networks in response to access from said user; wherein (a) said data center comprises a communication device that is given a unique address, a switch connected with this communication device, a data storage device connected with this switch that stores said service content, and a data management service server connected with said switch that manages said service content; and (b) said service provider comprises a communication device that is given a unique address, a communication adaptor connected with this communication device and which performs mutual conversion of communication protocols in said first network and said service provider, a system bus connected with this communication adaptor, and a service server connected with this system bus and which performs management of updating and downloading of said service content through said first and second networks.

### SUMMARY

However, the method described above has the following problems. Specifically, since, in providing the service, consideration is not given to the storage level i.e. the server composition of the data center, the security level of the center equipment and the fault recovery time, etc., makes it difficult to provide a service in accordance with the data storage level requested by the user.

In particular, since it is inefficient to always guarantee a region dedicated to a particular service in the case where the data capacity changes in a non-steady fashion, such as in cases where data awaiting processing is temporarily stored, consideration has been given to dynamically guaranteeing a region when needed. In these circumstances, while consideration may be given to storing data in another data center depending on the free capacity of the data center, or to guaranteeing a region by moving the data that is currently stored, provision of service in accordance with the data storage level requested by the user becomes increasingly difficult.

In view of the above, the present invention minimizes the cost of service provision in response to the circumstances involved in the temporary storage of data.

Specifically, an information processing device that performs management of data storage comprises: a data center table in which there are recorded, for each data center, the storage level, the storage cost, the total capacity and the free capacity; a data storage table in which there are recorded, for each set of data in respect of which data storage is accepted, the requested storage level and the default cost, if this storage level is not complied with; a storage case searching unit that accepts a data storage request from an input interface and searches cases under which data that is the subject of this data storage request may be stored in a data center having a free capacity of at least the storage data size, based on the storage data size included in this data storage request and said data center table; a storage cost calculation unit that calculates the storage cost required for each said case, based on said data center table and said storage data size; a default cost calculation unit that calculates the default cost required for each said case, based on said data storage table, and a case selection unit that calculates the total cost for each said case and effects data storage into this data center or that effects a storage request to this data center conforming to the case for which this total cost is a minimum.

Also, in a method of managing data storage by means of an information processing device comprising a data center table in which there are recorded the storage level, storage cost, total capacity and free capacity included in at least one item of information as to usability, security strength, performance, accuracy and installation durability for each data center and a data storage table in which are recorded for each set of data whose data storage is accepted, the requested storage level and default cost in the event that this storage level is not complied with, there is provided a data storage method characterized by comprising: a step of searching in a case to determine which data that is the subject of this data storage request is stored in a data center having a free capacity of at least the size of the storage data, based on the data center table and the storage data size included in this data storage request, on acceptance of a data storage request from an input interface; a step of calculating the storage cost required for each case based on the data center table and the storage data size; a step of calculating the default cost required for each case, based on the data storage table; and a step of calculating the total cost for each case and performing data storage in this data center, conforming to the case where this total cost is a minimum, or by requesting storage in this data center.

There is further provided, in a storage medium on which there is recorded a program for executing management of data storage on an information processing device comprising a data center table in which there are recorded the storage level, storage cost, total capacity and free capacity included in at least one item of information as to usability, security strength, performance, accuracy and installation durability for each data center and a data storage table in which there are recorded, for each set of data whose data storage is accepted, the requested storage level and default cost in the event that this storage level is not complied with, a computer readable storage medium on which there is recorded a program for executing on an information processing device a process including: a step of searching in cases to determine which data that is the subject of this data storage request may be stored in a data center having a free capacity of at least the size of the storage data, based on the data center table and the storage data size included in this data storage request, on acceptance of a data storage request from an input interface; a step of calculating the storage cost required for each case based on the data center table and the storage data size; a step of calculating the default cost required for each case, based on the data storage table; and a step of calculating the total cost for each case and performing data storage in this data center, conforming to the case where this total cost is a minimum, or by requesting storage in this data center.

This program is constituted of a code for performing the actions of the various steps.

Other objects and methods of achieving these features as disclosed by the present application will become clear from the following description of the embodiments and the applied drawings, according to the invention.

According to the present invention, the cost of providing a service is minimized in accordance with the conditions that accompany temporary storage of data.

### BRIEF DESCRIPTION OF THE DRAWINGS

FIG. 1 is a diagram showing an example of the overall construction of a data storage system, including an acceptance center module, according to an embodiment of the present invention;

FIG. 2 is a processing flow chart showing an example of an embodiment of the present invention;

FIG. 3 is a detailed processing flow chart showing an example of the step 10200 of FIG. 2;

FIG. 4 is a detailed processing flow chart showing an example of the step 10300 of FIG. 2;

FIG. 5 is a diagram showing an example of the layout of a table of the service acceptance information 210;

FIG. 6 is a diagram showing an example of the layout of a table of the storage center information 220;

FIG. 7 is a diagram showing an example of the layout of a table of the service provision cost information 230;

FIG. 8 is a diagram showing an example of the layout of a table of the data movement cost information 240; and

FIG. 9 is a diagram showing an example of the layout of a table of the data storage level information 250.

### DESCRIPTION OF THE PREFERRED EMBODIMENTS

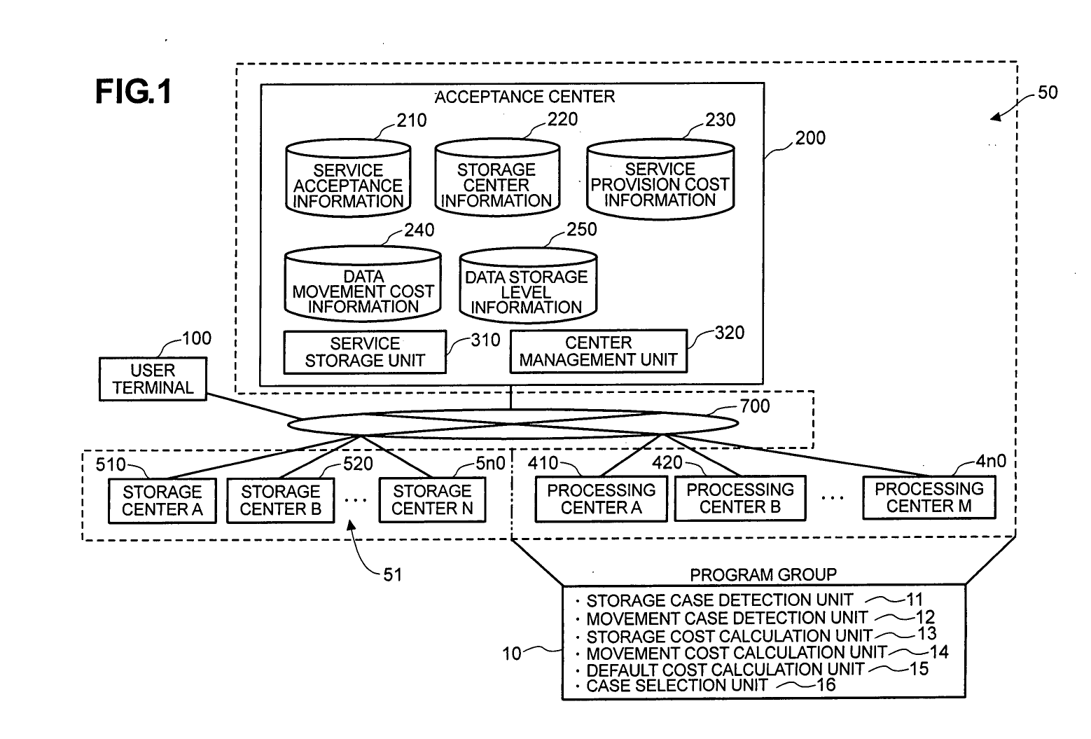

Embodiments of the present invention will be described in detail below with reference to the drawings. FIG. 1 is a system layout diagram showing a first embodiment of the present invention. As shown in this Figure, a user terminal 100, an acceptance center 200 that accepts requests for provision of services from the user terminal 100, processing centers 410 to 4n0 (where n is a natural number) that execute processing of services accepted by the acceptance center 200 and storage centers 510 to 5m0 (where m is a natural number) that store data processed by processing centers 410 to 4n0 (where n is a natural number), are connected by a network 700.

The acceptance center 200, the processing centers 410 to 4n0 and the storage centers 510 to 5n0 are devices comprising a memory that stores respective programs, calculation devices that execute the programs stored in memory, and input/output interfaces that exchange data by being connected with a network.

The storage centers 510 to 5n0 may comprise a recording medium, such as a magnetic disk, optical disk or magnetic tape, and a storage system comprising a controller that controls the input/output of data to the recording medium. An example that may be given of such a storage system is a disk array system wherein a plurality of magnetic disks constitute a RAID (redundant array of inexpensive disks) group; this comprises a plurality of magnetic disks and a disk controller that controls the input/output of data with respect to these magnetic disks. Another example that may be given of a storage system is an NAS (Network Attached Storage) wherein a disk array system, as described above, is further provided with a file system management unit which constructs a file system within the storage system, and wherein, when file access requests to files are received from another device through the network 700, the data of the files stored in the storage system can be accessed in response to such file access requests.

It should be noted that it is not essential that the storage centers 510 to 5n0 should be constituted by the same type of storage system. For example, a storage center A510 could be a disk array system (or NAS) having a plurality of FC disks having an FC (Fiber Channel) interface, a storage center B520 could be a disk array system (or NAS) having a plurality of ATA discs having ATA interfaces, and a storage center N5n0 could be a tape device provided with magnetic tape. The storage cost per unit quantity of data is highest in the case of an FC disk, and the next is an ATA disk, followed by magnetic tape, in that order. Thus, in such a case, the differences in storage cost, as described above, produced by the recording media are also reflected in the unit storage cost of the storage center information 220 (FIG. 6), to be described. Specifically, the unit storage cost decreases in the order of the storage center A510, the storage center B520, followed by the storage center N5n0.

However, the reliability of the recording medium is greater in the case of an FC disk than in the case of an ATA disk. Also, the speed of reading data is faster in the case of a magnetic disk, such as an FC disk or ATA disk, than it is in the case of a magnetic tape. The differences between the storage levels of the storage centers in terms of reliability and performance of the recording media, as described above, are recorded in the storage center information 220, to be described.

As an information-processing device 50 according to the present invention, a system may be envisioned in which the acceptance center 200 and processing centers 410 to 4n0 operate in integrated fashion. Also, storage centers 510 to 5m0 may be envisioned as data storage destinations. While a data center 51 could be constituted solely by such a storage center, it would also be possible to refer to a system including the aforesaid three centers as a data center.

Let us assume that one of the aforesaid centers has stored, in memory, programs individually matching the roles which it is to play, in accordance with the functions possessed by an information processing device according to the present invention, and in accordance with the mode of the system configuration, and that these programs are read by a calculation device and executed. Let us also assume that there is provided an input/output interface, connected with an external device, such as a user terminal 100, that performs exchange of data or data input/output via, for example, the network 700.

FIG. 1 shows a program group 10 into which the aforesaid programs are collected. This program group 10 is constituted by the programs employed by the various centers described above. According to this program, there may be provided, for example, a storage case detection unit 11 that searches for cases of the storage of the data in question that is the subject of a data storage request in data centers having a free capacity of at least the storage data size, and a movement case detection unit 12 that searches for cases of the storage of the data in question that is the subject of a data storage request in the data center by moving other data that has already been stored therein to another data center.

Apart from this, there are provided a storage cost calculation unit 13 that calculates the storage cost required for each aforesaid case, based on the data center table and the storage data size; a movement cost calculation unit 14 that calculates the data movement cost required for each aforesaid case, based on the data movement cost table (to be described: data movement cost information 240) and the storage data size; and a default cost calculation unit 15 that calculates the default cost that is required for each aforesaid case based on the data storage table (to be described: data storage level information 250).

In addition, there is provided a case selection unit 16 that calculates the total cost for each aforesaid case and performs data storage into the data center in question conforming to the case for which this total cost is a minimum or that makes a storage request to this data center.

The acceptance center 200, that plays the chief role as information processing device according to the present invention in this embodiment, comprises a service management unit 310 and a center management unit 320. The service management unit 310 performs reading and updating of the service acceptance information 210 and the service provision cost information 230. The center management unit 320 performs reading and updating of the storage center information 220, data movement cost information 240 and data storage level information 250.

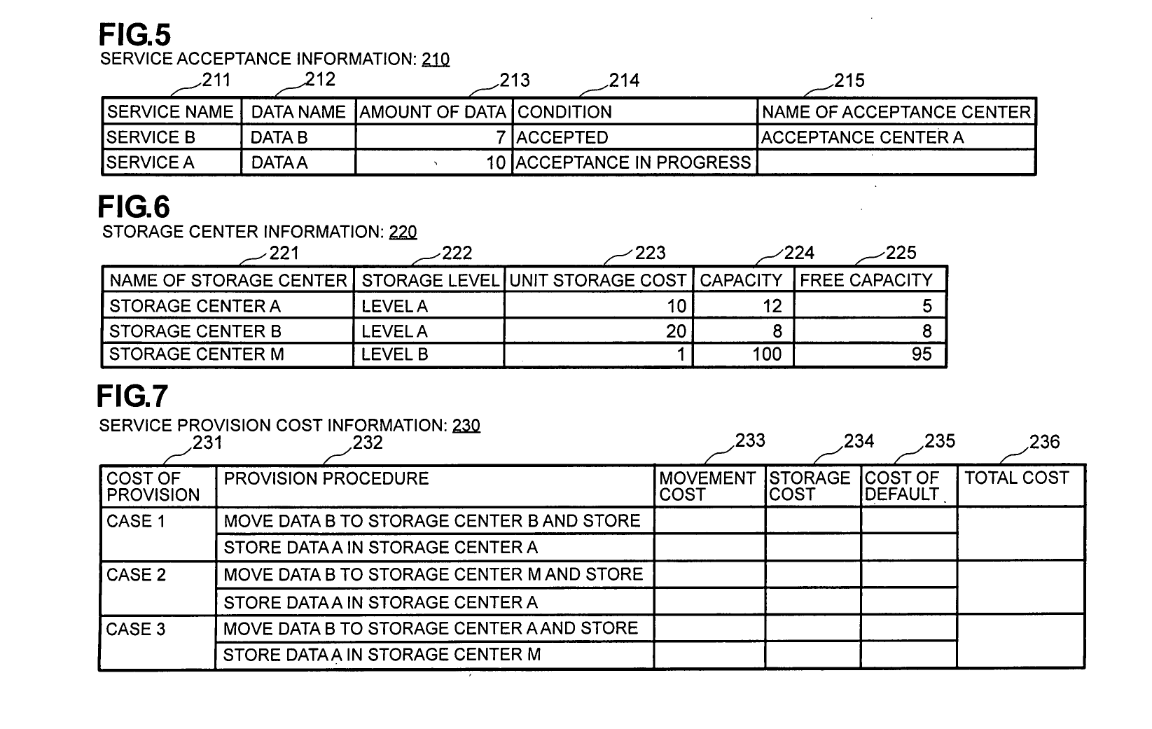

Next, the various types of tables that are provided at the acceptance center 200 will be described in detail. FIG. 5 is a diagram of the table layout of the service acceptance information 210. The service acceptance information 210 saves the information provided in a service request accepted from the user terminal 100 and includes the service name 211, data name 212, data amount 213, condition 214 and storage center name 215.

The service name 211 comprises information for uniquely specifying the content of a service provision request accepted from a user terminal 100 by the service management unit 310. Also, the data name 212 is information for specifying data on which processing is to be performed in the service specified by the service name 211, in respect of which a request for provision was received. Also, the data amount 213 indicates the capacity required to store the data specified by the aforesaid data name 212 in the storage centers 510 to 5m0 (where m is a natural number). In addition, the condition 214 indicates the state of progress of service processing specified by the service name 211, in respect of which a request for provision was received.

In this embodiment, the condition 214 may take two values, namely, “acceptance in progress” and “accepted”. “Acceptance in progress” indicates a condition in which the service management unit 310 has accepted a service provision request, but the storage center 510 to 5m0 (where m is a natural number) that is to be the destination for storage of the data that is to be processed by this service has not yet been decided. “Accepted” indicates a condition in which, after the service management unit 310 has accepted a service provision request, the storage center 510 to 5m0 (where m is a natural number) that is to be the destination for storage of the data that is to be processed by this service has now been determined.

Also, the storage center name 215 is information for uniquely specifying the storage center 510 to 5m0 (where m is a natural number) that is to store the data specified by the data name 212.

FIG. 6 is a table layout diagram of the storage center information 220. The storage center information 220 constitutes information relating to the storage centers 510 to 5m0 (where m is a natural number). According to the present invention, it comprises a data center table in which there are recorded the storage level, storage cost, total capacity and free capacity, including at least one item of information of the reliability, usability, security strength, performance, accuracy and equipment durability for each data center. This storage center information 220 comprises the storage center name 221, management table 222, unit management cost 223, capacity 224 and free capacity 225.

The storage center name 221 is information for uniquely specifying a storage center 510 to 5m0 (where m is a natural number). Also, the storage level 222 specifies the level of data storage capable of being provided at the storage centers 510 to 5m0 (where m is a natural number) specified by the storage center name 221. In general, various items may be specified for determining the storage level 222, such as whether the equipment at the processing center is earthquake proof, the degree of encryption of data and the communication network, the degree of data redundancy and the reliability or performance of the recording media provided at the storage center; however, in accordance with the present invention, the method of determining the level is not in question. Rather, the present invention is concerned with specifying relative levels of data storage that may be provided at the storage centers 510 to 5m0 (where m is a natural number). Accordingly, in this embodiment, the storage levels 222 are indicated in the order of the height of the level as “level A”, “level B”, . . . “level X”.

Also, the unit storage cost 223 specifies the cost per unit amount of data required when data is stored in the storage center 510 to 5m0 (where m is a natural number) specified by the storage center name 221. For example, the storage cost, when the data identified as “data B” by the data name 212 indicated at line 2 of FIG. 5 is saved in the storage center identified as “storage center A” by the storage center name 221 indicated at line 2 in FIG. 6, is calculated as “70” by multiplying “7”, which is the amount of data 213 of the data B, by “10”, which is the unit storage cost 223 of the storage center A.

In addition, the capacity 224 specifies the maximum data capacity that is capable of being stored in the storage centers 510 to 5m0 (where m is a natural number) specified by the storage center name 221. Also, the free capacity 225 specifies the amount of data currently capable of being saved in the storage center 510 to 5m0 (where m is a natural number) specified by the storage center name 221, when the amount of data currently stored is subtracted from the capacity 224.

FIG. 7 is a table layout diagram of the service provision cost information 230. The service provision cost information 230 comprises the service provision procedures and the results of calculation of the cost in each of these service provision procedures, and, more specifically, it comprises the cost of provision 231 on a case by case basis, the provision procedure 232, the movement cost 233, the storage cost 234, the default cost 235 and the total cost 236.

The cost of provision 231 constitutes information for uniquely specifying respective provision patterns when one or more provision patterns are considered, depending on the data movement destination for a storage destination, when providing a service accepted by the service management unit 310.

Also, the provision procedure 232 stores the procedure used for executing the pattern of provision specified by the provision case 231.

In this embodiment, the cost of provision 231 and the provision procedure 232 are shown when the service A of the third line in FIG. 5 is to be provided. This indicates that, in order to provide the service A, there are three provision cases 231, namely, “case 1”, “case 2” and “case 3”. Also, in order to execute “case 1”, the two procedures, namely, “move the data B to the storage center B and store it” and “store the data A in the storage center A” are necessary.

The movement cost 233 is the necessary cost in respect of data movement when executing the provision procedure 232. Also, the storage cost 234 is the necessary cost in respect of data storage when executing the provision procedure 232.

The default cost 235 is the necessary cost if the storage level required for storage cannot be provided when executing the provision procedure 232. Also, the total cost 236 is the value obtained by totaling, for each provision case 231, the movement cost 233, the storage cost 234 and the default cost 235.

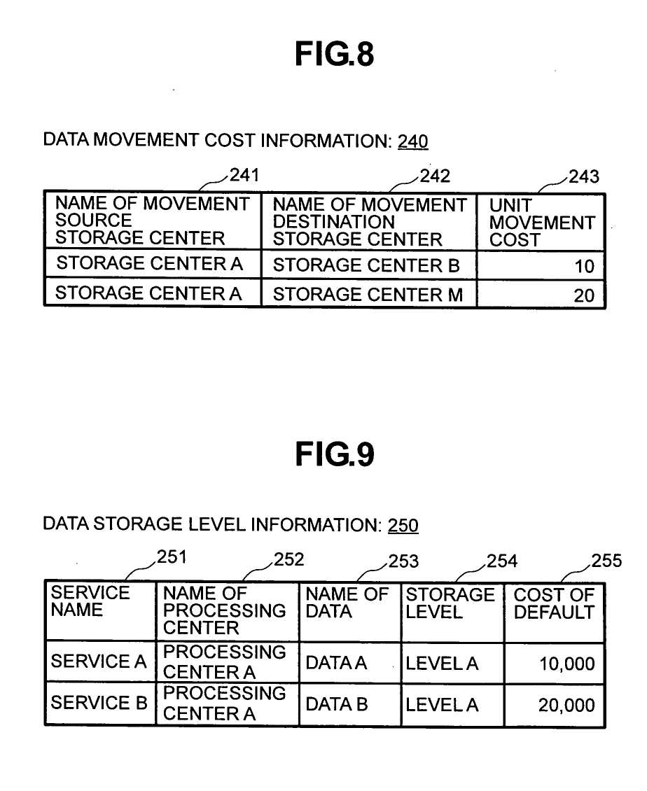

FIG. 8 is a diagram of the table layout of the table movement cost information 240. The data movement cost information 240 is the necessary cost when moving data between the storage centers 510 to 5m0 (where m is a natural number). In this way, by registering beforehand the cost of a data movement between storage centers, it is possible to calculate the service provision cost, including the movement cost generated, for example, when a storage center wherein the data storage level is satisfied cannot be used, due to the free capacity or state of use of the storage center, and the necessary region is guaranteed by moving, to another storage center, the data that has already been saved. That is, this is a data movement cost table in which the unit movement cost is recorded when moving data between data centers according to the present invention.

The data movement cost information 240 comprises the movement source storage center name 241, the movement destination storage center name 242 and the unit movement cost 243. Also, the movement source storage center name 241 is information for uniquely specifying the storage center 510 to 5m0 (where m is a natural number) in which, when data is moved, the data was stored prior to movement.

The movement destination storage center name 242 is information for uniquely specifying the storage center 510 to 5m0 (where m is a natural number) where, when data is moved, the data is stored after movement.

Also, the unit movement cost specifies the cost per unit capacity required when moving data from the movement source storage center 241 to the movement destination storage center 242. For example, the movement cost, when the data whose data name 212 is “data B”, indicated in line 2 of FIG. 5, is moved from the storage center whose movement source storage center name 241, shown in line 2 of FIG. 7, is “storage center A” to the storage center whose movement source storage center name 242 is “storage center B”, is calculated as “70” by multiplying “7”, which is the amount of data 213 of the data B, by “10”, which is the unit movement cost 243 for movement of the data from the storage center B to the storage center A.

FIG. 9 is a table layout diagram of the data storage level information 250. This is a data storage table in which there are recorded the requested storage level and the default cost if this storage level is not complied with, for each set of data whose data storage is accepted. According to the present invention, the storage level of the data which can be provided by the storage center is registered beforehand. As examples of storage levels, the height of the storage level that can be provided by a center may be defined as, for example, level A: “earthquake resistance (equipment durability) of the center: M9, usability: 99.99%, network (security strength): 128 bit SSL” or level B: “earthquake resistance of the center: M8, usability: 99%, network 40 bit SSL”.

Also, there are registered beforehand the storage level necessary for storage of the data in service provision and the default cost arising in the case where this storage level is not achieved. This default cost is the actual sum of money to be paid on default and is a numerical value representing the risk of loss of social confidence as a result of the default. Thus, by defining the storage level of the storage center, the storage level of the data, and the default cost, it is possible to select the storage destination for which the cost of provision of the service required for storage is minimized and the risk is minimized, including the case where no storage center that satisfies the data storage level can be utilized, due to the situation regarding the free capacity or condition of use of the storage center.

The data storage level information 250 comprises the service name 251, the processing center name 252, the data name 253, the storage level 254 and the default cost 255. Also, the service name is information uniquely specifying a service that can be accepted by the service management unit 310.

The processing center name 252 is information uniquely specifying the processing center 410 to 4n0 (where n is a natural number) that executes the processing of the service indicated by the service name 251. Also, the data name 253 is information uniquely specifying the data in respect of which processing is performed in the processing center 410 to 4n0 (where n is a natural number) indicated by the processing center name 252.

The storage level 254 indicates the storage level 222 of the storage center 510 to 5m0 (where m is a natural number) that is required when storing the data indicated by the data name 253 in the storage center 510 to 5m0 (where m is a natural number).

Also, the default cost 255 specifies the cost that is generated if, when storing the data indicated by the data name 253 in the storage center 510 to 5m0 (where m is a natural number), it is not possible to provide the storage level indicated by the storage level 254. As an example, let us consider the case where data A indicated in the first line of the table in FIG. 9 is stored. Since the storage level 254 of the data A is “level A”, the storage level 222 of the storage center 510 to 5m0 (where m is a natural number) must be at least “level A”. Referring to FIG. 6, the reason why the storage level 222 is at least “level A” is that this is the level of the “storage center A” of the first line of the table in FIG. 6 and of the “storage center B” of the second line of the table in FIG. 6. If the “data A” were to be stored in the “storage center M”, whose storage level 222 is less than “storage level A”, the storage level of storage level 254 could not be provided, so a default cost 255 of “10,000” would be generated.

Regarding the network 700, apart from the Internet or a LAN, various types of network can be adopted, such as a private circuit, a WAN (wide area network), an electric light wiring network, a wireless network, a public switched network, or a portable telephone network. Also, when employing the Internet, it is convenient if communication with increased security is established using virtual private network technology, such as VPN.

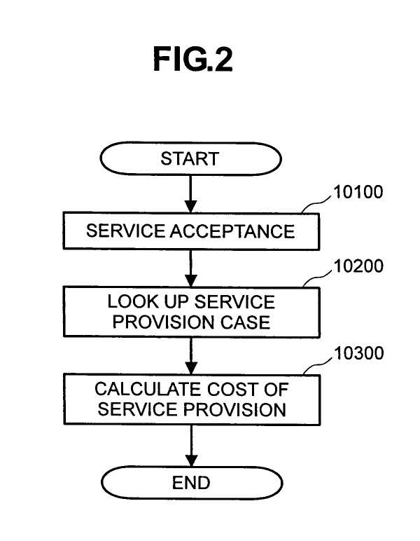

Next, the processing action of this embodiment will be described with reference to the flow charts of FIGS. 2 to 4 and with reference to FIGS. 5 to 9, described above. In this embodiment, it will be assumed that, for example, the acceptance center 200 chiefly executes processing as an information-processing device. Accordingly, the acceptance center 200 executes processing as follows.

The service management unit 310 in the acceptance center 200 accepts a service provision request from a user terminal 100 and registers this request in the service acceptance information 210 (step 10100). In the example shown at the second line of the table of FIG. 5, the service management unit 310 accepts a provision request for the service whose service name 211 is “service A” and simultaneously indicates receipt of data whose data name 212 is “data A” and whose data amount 213 is “10”. At this point, the storage center name 215 has not yet been determined and is therefore blank, and, furthermore, the condition 214 is “acceptance in progress”.

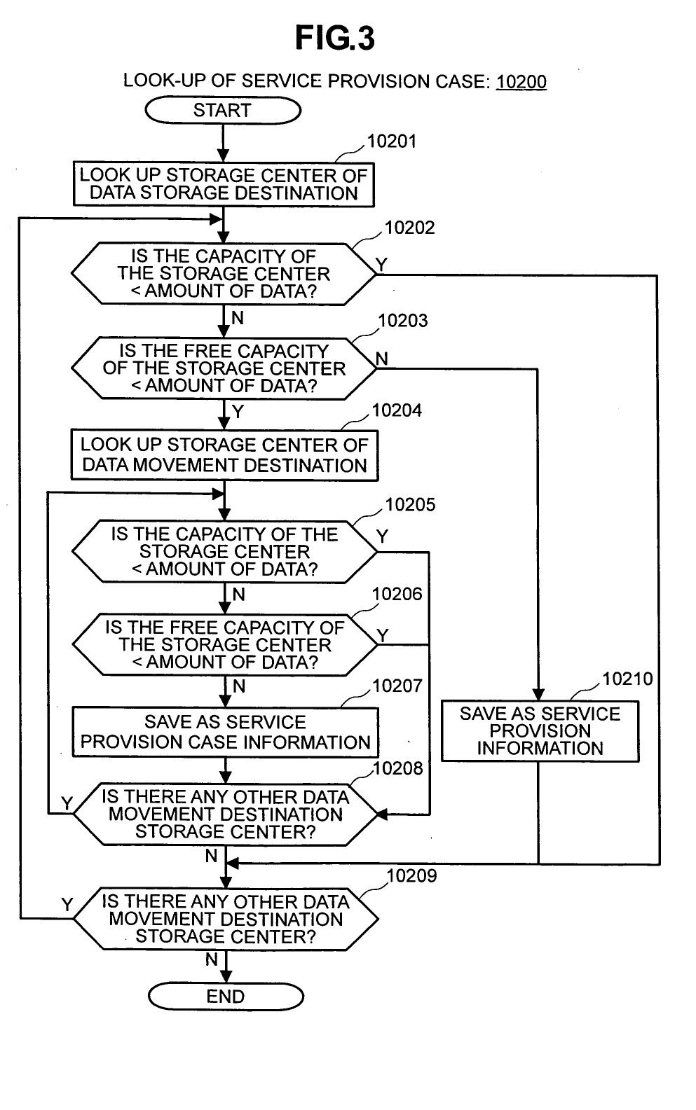

Also, the service management unit 310 searches all of the patterns for storage of data received in the aforesaid step 10100 in the service provision and registers these in the service provision cost information 230 (step 10200). The details of this processing will be described using the service provision case searching flow chart of FIG. 3.

First of all, the center management unit 320 searches (step 10201) for the storage center 510 to 5m0 (where m is a natural number), which is to be the storage destination of the data accepted in the step 10100. Specifically, the center management unit 320 searches the storage center name 221 which is at the head of the storage center information 220. In the example of FIG. 6, the indication “storage center A”, which is the data storage destination storage center at the first line of the table, is retrieved.

Next, the service management unit 310 compares the capacity 224 of the storage center selected in the aforesaid step 10201 or step 10209 with the data amount 213 received in the aforesaid step 10100; and, if the data amount 213 is larger than the capacity 224 of the storage center, it proceeds to the processing of step 10209, and, if the capacity 224 of the storage center is greater than or equal to the data amount 213, it proceeds to the processing of step 10203 (step 10202). In the example of FIG. 6, “storage center A”, selected in step 10201, has a capacity 224 equal to “12”, and the data amount 213 of the data A is at least “10”, so processing advances to step 10203.

Also, the service management unit 310 compares the free capacity 225 of the storage center selected in the aforesaid step 10201 or step 10209 with the data amount 213 received in the aforesaid step 10100; and, if the data amount 213 is larger than the free capacity 225 of the storage center, it proceeds to the processing of step 10210, and, if the free capacity 225 of the storage center is greater than or equal to the data amount 213, it proceeds to the processing of step 10204 (step 10203). In the example of FIG. 6, the “storage center “A”, selected retrieved in step 10201, has a free capacity 224 equal to “5”, and the data amount 213 of the data A, being “10”, is larger than this free capacity 224, so processing proceeds to step 10204. Specifically, this indicates that, although the data A cannot directly be saved to the storage center A in this condition, the data A can be saved to the storage center A by moving the data that is currently saved in the storage center A to another storage center.

Next, the data that is currently stored in the storage center that was selected in the step 10201 or the step 10209 is retrieved, and an indication of the storage center 510 to 5m0 (where m is a natural number) that is to be the destination of movement of this data is retrieved (step 10204). Specifically, in step 10203, the center management unit 320 searches, in the storage center information 220, for the storage center name 221 that is at the head thereof, excluding any storage center indication that was retrieved in step 10201 or step 10209. From the example of FIG. 5, the data B is retrieved as the data stored in the storage center A. Specifically, this data B is the data that is to be the subject of movement. Also, in the example of FIG. 6, the information “storage center B” at the second line of the table is retrieved as an indication of the storage center that is to be the destination of this data movement.

Also, the service management unit 310 compares the capacity 224 of the storage center selected in step 10204 or step 10208 with the data amount 213 of the data retrieved as the subject of movement in step 10204; and, if the data amount 213 is larger than the capacity 224 of the storage center, it advances to the processing of step 10208, and, if the capacity 224 of the storage center is at least equal to the data amount 213, it advances (step 10205) to the processing of step 10206. In the example of FIG. 6, the “storage center B” selected in step 10201 has a capacity 224 equal to “8”, and the data amount 213 of the data B is “7” or more, so processing advances to step 10206.

Next, the service management unit 310 compares the free capacity 225 of the storage center selected in step 10204 or step 10208 and the data amount 213 of the data retrieved as the subject of movement in step 10204; and, if the data amount 213 is larger than the free capacity 225 of the storage center, it advances to the processing of step 10208, and, if the free capacity 225 of the storage center is at least equal to the data amount 213, it advances to the processing of step 10206 (step 10206). In the example of FIG. 6, the “storage center B” that was selected in step 10201 has a free capacity 225 of “8” and the data amount 213 of the data B, which is the data retrieved as the subject of movement in step 10204, is at least “7”, so processing advances to step 10207. That is, this indicates that the data B can be moved to the storage center B and stored.

Also, the service management unit 310 saves, in the service provision cost information (step 10207), information as to the data whose storage destination was determined in step 10203 and a step 10206. Specifically, in step 10206, movement and storage of the data B in the storage center B were decided upon, so this information relating thereto is saved in the provision procedure 232. The first line of the table in FIG. 7 shows the results of thus saving the procedure information. Also, in step 10203, it was decided that the data A should be stored in the storage center A, so this information is saved in the provision procedure 232. Line 2 of the table of FIG. 7 shows the results of thus saving the procedure information. After all of these items of provision procedure information 232 have been saved, a provision case name is saved in the cost of provision column 231, in order to identify the provision case corresponding to this series of procedures. In the example of FIG. 7, this is “case 1”.

The center management unit 320 searches (step 10208) to ascertain whether any other storage center which constitutes a data movement destination exists, apart from the data destination storage center that was selected in step 10204; and, if such other storage center exists, it proceeds to step 10205, while, if such a storage center does not exist, it proceeds to step 10209. Specifically, since the center B was designated in step 10204, the center management unit 320 proceeds to step 10205, since a storage center M exists which is the next storage center following the storage center B in the storage center name column 221.

Also, the center management unit 320 searches (step 10209) to ascertain whether any storage center exists which is a data storage destination, apart from the storage center which is the data movement destination that was designated in step 10201, and, if such a storage center exists, proceeds to step 10202, or, if a such a storage center does not exist, it proceeds to step 10300. Specifically, since the center A was designated in step 10201, the center management unit 320 proceeds to step 16202, since a storage center B exists as the next storage center following the storage center A in the storage center name column 221.

In addition, in the same way as in the case of step 10207, the service management unit 310 saves (step 10210), in the service provision cost information, information constituting data as to which storage destination was decided upon in step 10203.

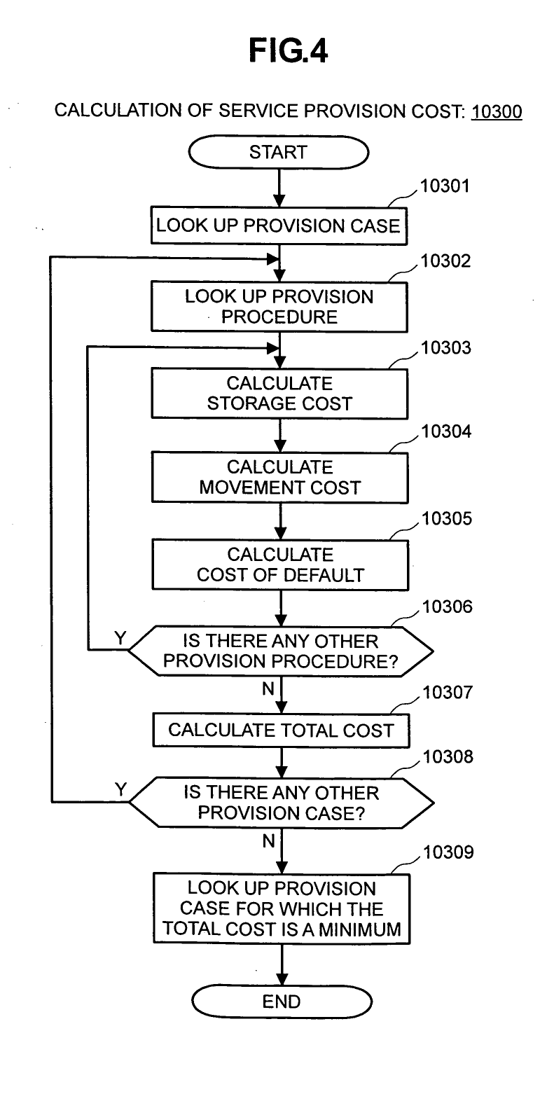

Also, the optimum service provision case, of all of the service provision cases 231 that were designated in step 10200, is selected (step 10300) by calculating the necessary cost for service provision. The details thereof will be described using the calculation flow chart of FIG. 4 of the service provision cost.

The service management unit 310 searches the cost of provision case column 231 which is at the head of the service provision information 230 (step 10301). In the example of FIG. 7, “case 1”, which is at the first line of the table, is retrieved as the cost of provision case 231.

Also, of the provision cases 231 selected in step 10301 or step 10308, the provision procedure 232 which is at the head thereof is retrieved from the service provision information 230 (step 10302). In the example of FIG. 7, “move the data B to the storage center B and store”, which is at the first line of the column is retrieved as the provision procedure 232.

In addition, the storage cost 234 of the provision procedure 232, which was selected in step 10302 or step 10306, is calculated (step 10303). In the example of the first line of the column 232 in FIG. 7, the storage cost 234 in the case of storing the data B in the storage center B is calculated from the provision procedure 232. The service management unit 310 then searches the service acceptance information 210 for the data amount 213 of the information whose data name 212 is “data B”. In the example of FIG. 5, the data amount “7” at the first line of column 213 is retrieved. Also, at the same time, the service management unit 310 searches the unit storage cost 223 for the information whose storage center name 221 is “storage center B”, from the storage center information 220. In the example of FIG. 6, the unit storage cost “20”, which is at the second line of column 223, is retrieved. The storage cost 234 is then calculated as “140” by multiplying the value “7” of the data amount 213 by the unit storage cost 223, which is “20”.

Also, the movement cost 233 of the provision procedure 232 that was retrieved in step 10302 or step 10306 is calculated (step 10304). In the example of the first line of the column 232 of FIG. 7, the storage cost 234, when the data B, is stored in the storage center B is calculated from the provision procedure 232. Thereupon, the service management unit 310 searches, from the service acceptance information 210, the storage center name 215 with the information that the data name 212 is “data B”. If no storage center name 215 is designated, this data must have been newly stored and no data movement between storage centers can have taken place, so the movement cost 233 is set to “0” and processing advances to step 10305. However, if a value of the storage center name 215 has indeed been designated, this value is compared with the storage center name that was designated by the provision procedure 232. If these two are the same, no data movement between storage centers can have taken place, so the movement cost 233 is set to “0” and processing advances to step 10305. If these two are different, movement of data between the storage centers must have occurred. In the example of FIG. 5, the designation “acceptance center A” at the first line of column 215 is retrieved, which is different from the “storage center B” of the provision procedure 232 of the first line of column 232 of FIG. 7. Specifically, in this example, this indicates that the “data B” has been moved from “storage center A” to “storage center B”.

Next, the service management unit 310 searches the data movement cost information 240 and searches the unit movement cost 243. In the example of the provision procedure 232 of the first line of FIG. 7, the “data B” was moved from “storage center A” to “storage center B”; therefore, when the facts that the movement source storage center name 241 is “storage center A” and the movement destination storage center name 242 is “storage center B” are retrieved, the search result is obtained from the data movement cost information 240 that the unit movement cost 243 on the first line of column 243 is “10”. The movement cost 233 is calculated by multiplying the amount of data 213 by this unit movement cost 243. In the example of the provision procedure 232 at the first line of the table of FIG. 7, the data amount 213 is “7” and the unit movement cost 243 is “10”, so the movement cost 233 is calculated as “70”.

In addition, the movement cost 235 of the provision procedure 232 that was searched in step 10302 or step 10306 is calculated (step 10305). Also, the service management unit 310 searches the storage level 222 that can be provided by the storage center indicated in the provision procedure 232, from the storage center information 220. Next, the service management unit 310 searches the storage level 254 necessary for data storage indicated by the provision procedure 232, from the data storage level information 250.

Also, this storage level 222 and the storage level 254 are compared. If the storage level 222 is greater than or equal to the storage level 254, the storage level that can be provided by the storage center satisfies the storage level 254 that is required for data storage, so that the default cost 235 is “0”. However, if the storage level 222 is lower than the storage level 254, the storage level that can be provided by the storage center does not satisfy the storage level 254 that is required for data storage, so that the amount of the default cost 235 indicated by the default cost 255 is generated.

In the example of the provision procedure 232 at the first line of the table in FIG. 7, the storage level 222 that can be provided by the “storage center B” is searched from the storage center information 220 and “level A” indicated in the second line of the table in FIG. 6 is thereby obtained. Next, since the storage level 252 required for storing the “data B” is “level A”, it is found that the storage level that can be provided by the storage center satisfies the storage level 254 required for this data storage, so that the default cost 235 is “0”.

Next, for the provision case 231 that was selected in step 10301 or step 10308, the service management unit 310 searches the service provision cost information 230 to ascertain whether any provision procedure 232 exists subsequent to the provision procedure 232 that was retrieved in step 10302 or step 10306. If such a subsequent provision procedure 232 exists, processing advances to step 10303. If such a subsequent provision procedure 232 does not exist, processing advances (step 10306) to step 10307. In the example of the provision procedure 232 at the first line of the table in FIG. 7, the provision case 231 is “case 1” and the provision procedure “store the data A in the storage center A” exists at the next i.e. the second line of the table, so processing advances to step 10303.

Also, the total cost 236 is calculated (step 10307) by totaling the movement cost 233, the storage cost 234, and the default cost 235 of the provision case 231 selected in step 10301 or step 10308. Furthermore, the service management unit 310 searches the service provision cost information 230 to ascertain whether any provision case 231 exists subsequent to the provision case 231 that was retrieved in step 10301 or step 10308. If such a subsequent provision case 231 exists, the processing advances to step 10302. If such a subsequent provision case 231 does not exist, the processing advances (step 10308) to step 10309.

Finally, the service management unit 310 searches the provision case 231 for which the total cost 236 is a minimum (step 10309). In the example of FIG. 7, the total cost of “case 1” is a minimum. The entire storage processing is then completed by performing data storage, in accordance with this case for which the total cost is a minimum, to the data center in question that conforms to this case, or by making a request for storage to this data center.

As described above, according to the present invention, it is possible to specify the data center for which the cost required for service provision and associated risk are a minimum, based on: the service provision cost, such as the default cost, if it is not possible to provide the storage level required for the data storage, and the movement cost if movement of data between storage centers is required.

In other words, the cost of service provision is minimized in response to the circumstances accompanying temporary storage of data.

Although a specific description of the present invention has been given with reference to embodiments thereof, the present invention is not restricted to these embodiments and can be modified in various ways without departing from its gist.

1. An information processing device that performs management of data storage, comprising:
a data center table in which are recorded the storage level, storage cost, total capacity, and free capacity for each data center;
a data storage table in which are recorded the requested storage level and default cost if the storage level is not complied with, for each set of data in respect of which a data storage request is accepted;
a storage case searching unit which, on receiving a data storage request from an input interface, searches cases in which storage data contained in the data storage request is able to be stored in a data center having a free capacity of at least the size of the storage data, based on the size of the storage data and said data center table;
a storage cost calculation unit that calculates the storage cost required for each said case, based on said data center table and said storage data size;
a default cost calculation unit that calculates the default cost that is required for each said case, based on said data storage table; and
a case selection unit that calculates the total cost for each said case and selects whether data is stored in the data center or whether a data storage request is made to the data center, in accordance with the case for which the total cost is a minimum.

2. The information processing device according to claim 1, further comprising:
a data movement cost table that records a unit movement cost in moving data between data centers;
a movement case searching unit that searches cases in which storage data contained in said data storage request is able to be recorded in a data center by moving other data, that has already been stored, to another data center; and
a movement cost calculation unit that calculates the data movement cost required for each case searches by said movement case searching unit, based on said data movement cost table and said storage data size.

3. The information processing device according to claim 1, wherein said storage level includes information concerning at least one of the reliability, performance and equipment durability of the data center.

4. A data storage method in an information processing device which comprises a data center table in which are recorded the storage level, the storage cost, total cost and free capacity of each data center, and a data storage table in which are recorded the storage level required and the default cost if the storage level is not complied with, for each set of data in respect of which a data storage request has been accepted, said method comprising the steps:
receiving a data storage request from an input interface, and searching cases in which storage data contained in the data storage request is able to be stored in a data center having a free capacity of at least the size of the storage data, based on the size of the storage data and said data center table;
calculating the storage cost required for each said case, based on said data center table and said storage data size;
calculating the default cost that is required for each said case, based on said data storage table; and
calculating the total cost for each said case and controlling data storage to the data center in accordance with the for which the total cost is a minimum.

5. A computer program product for use in an information processing device, comprising:
a recording medium;
a data center table, which is recorded in said recording medium, and in which are recorded a storage level, storage cost, total capacity and free capacity for each data center;
a data storage table, which is recorded in said recording medium, and in which are recorded a requested storage level, and the default cost if the storage level is not complied with, for each set of data in respect of which data storage is accepted;
a code, which is recorded in said recording medium, for receiving a data storage request from an input interface, and searching a case in which storage data contained in the data storage request is able to be stored in a data center having a free capacity of at least the size of the storage data, based on the data center table and the size of the storage data;
a code, which is recorded in said recording medium, for calculating the storage cost required for each case based on said data center table and said storage data size;
a code, which is recorded in said recording medium, for calculating the default cost required for said each case, based on said data storage table; and
a code, which is recorded in said recording medium, for calculating the total cost for each said case and controlling data storage to the data center in accordance with the case for which the total cost is a minimum.
